(19) United States
(12) Patent Application Publication
(10) Pub. No.: US 2006/0151256 A1
(43) Pub. Date: Jul. 13, 2006

(54) Elevator with voice recognition floor assignment device

(76) Inventor: Jae Ho Lee, Allendale, NJ (US)

Correspondence Address: MCCARTER & ENGLISH, LLP, FOUR GATEWAY CENTER, 100 MULBERRY STREET, NEWARK, NJ, 07102, US

(21) Appl. No.: 11/327,579

(22) Filed: Jan. 6, 2006

(30) Foreign Application Priority Data
Jan. 7, 2005 (KR) 10-2005-0001482

(51) Int. Cl. B66B 1/34

(52) U.S. Cl. 187/391

(57) ABSTRACT

The present invention relates to an elevator, and more particularly, to an elevator in which a floor number can be specified through voice recognition. To this end, the elevator includes a microphone 14 installed within an elevator 10, voice recognition means 27 for recognizing voice information received from the microphone 14 and generating the recognized voice information as text data, extraction means for extracting an associated number based on the generated text data, and specifying means for specifying the associated number extracted by the extraction means as a button input value of a floor number to which the elevator 10 will move.

### CROSS-REFERENCE TO RELATED APPLICATION

This application claims the priority of Korean Patent Application No. 10-2005-0001482 filed Jan. 7, 2005, the disclosure of which is incorporated herein by reference in its entirety for all purposes.

### BACKGROUND OF THE INVENTION

1. Field of the Invention

The present invention relates to an elevator, and more particularly, to an elevator in which a floor number can be specified through voice recognition.

2. Background of the Related Art

In general, an elevator is provided with buttons for specifying a floor number. A passenger in the elevator can specify a desired floor number by pressing the button of the floor number.

In the case where a lot of people board the elevator, it is very difficult to press the button due to the crowded people. To solve this problem, two sets of floor number buttons are provided within one elevator in case of a large-scale elevator.

In the case of an elevator that is used by many people, such as in hospitals, airports and terminals, floor number buttons are contaminated with lots of germs, bacilli, etc., since many people press the buttons. This has a bad effect upon public sanitation. Therefore, the elevator must be cleaned and managed regularly in order to maintain cleanness.

In some elevators, floor number buttons are erroneously pressed due to clothes or the human body when the elevators are crowded with people. Moreover, there is a case where children cannot press the floor number buttons since the floor number buttons are disposed at a too high position.

Furthermore, the blind suffers from an inconvenience of having to grope about buttons in order to find braille type.

### SUMMARY OF THE INVENTION

Accordingly, the present invention has been made in view of the above problems occurring in the prior art, and it is an object of the present invention to provide an elevator in which a passenger can specify a floor number through voice.

Another object of the present invention is to provide an elevator that can run without any error in such a manner that a passenger can confirm a floor number specified through voice recognition.

To achieve the above objects, in an aspect of the present invention, there is provided an elevator in which a floor number is specified through voice recognition, including: a microphone installed within the elevator; voice recognition means for recognizing voice information received from the microphone and generating the recognized voice information as text data; extraction means extracting an associated number based on the generated text data; and specifying means for specifying the associated number extracted by the extraction means as a button input value of a floor number to which the elevator will move.

The elevator may further include converting means for converting the associated number extracted by the extraction means into voice data, and a speaker installed within the elevator for outputting the voice data.

The elevator may further include determination means for determining whether affirmative sentences are included in the text data generated through the microphone and the voice recognition means after the speaker has output the voice data.

The voice recognition means may include an affirmative sentence table that includes voice data regarding an affirmative answer.

The microphone may be installed at a central region of the ceiling of the elevator.

The elevator may further include an A/D converter for converting the voice information received from the microphone into a digital signal.

### BRIEF DESCRIPTION OF THE DRAWINGS

Further objects and advantages of the invention can be more fully understood from the following detailed description taken in conjunction with the accompanying drawings in which:

FIG. 1 is a perspective view schematically illustrating an elevator in which a floor number can be specified through voice recognition according to the present invention;

FIG. 2 is a flowchart illustrating an operational sequence of the elevator shown in FIG. 1;

FIG. 3 is a schematic block diagram of a system for specifying a floor number through voice recognition in the elevator shown in FIG. 1; and

FIG. 4 shows a part of a register map of an affirmative sentence table 40 in FIG. 3.

### DETAILED DESCRIPTION OF THE PREFERRED EMBODIMENT

The present invention will now be described in detail in connection with preferred embodiments with reference to the accompanying drawings.

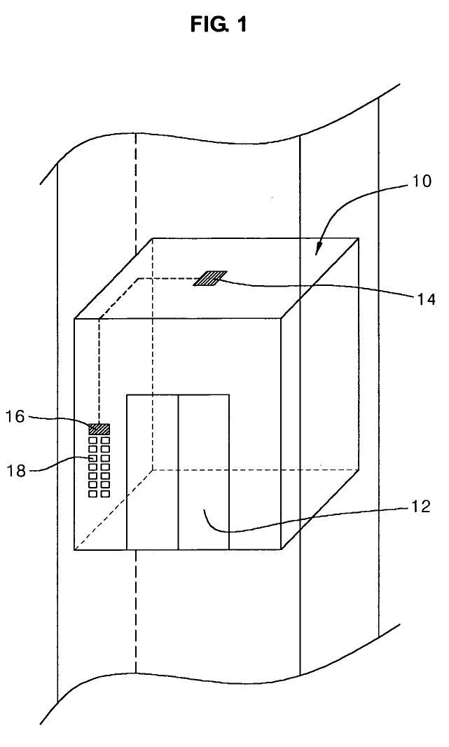

FIG. 1 is a perspective view schematically illustrating an elevator in which a floor number can be specified through voice recognition.

As shown in FIG. 1, an elevator 10 includes floor number buttons 18 disposed at one side of a door 12. A speaker 16 is installed over the floor number buttons 18. A directional microphone 14 is installed at the center of the ceiling of the elevator. Furthermore, though not shown in FIG. 1, a variety of electronic devices for operating the elevator 10, such as a microcomputer, a relay and switches, are installed on a rear surface of the floor number buttons 18.

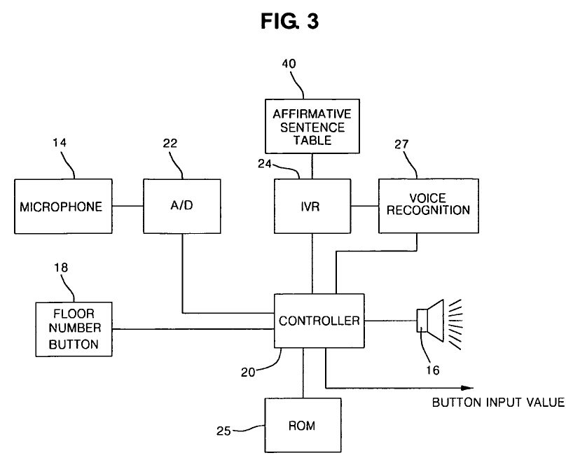

FIG. 3 is a schematic block diagram of a system for specifying a floor number through voice recognition in the elevator shown in FIG. 1.

As shown in FIG. 3, voice received through the microphone 14 is converted into a digital signal through an A/D converter 22 and is then transmitted to a controller 20. A key value of the floor number buttons 18 is also input to the controller 20. The reason for this is that voice recognition and the pressing of the floor number buttons 18 can be used together.

Interactive Voice Response (IVR) 24 is a module that communicates with a passenger for voice recognition. Voice guide for various situations that are determined in the controller 20 is previously recorded in the IVR module 24. Therefore, a passenger can feel that he is kindly guided by an attendant. The IVR module 24 can be applied to various fields such as telephone guide.

A voice recognition unit 27 is connected to the controller 20 and the IVR nodule 24. The voice recognition unit 27 is a module that recognizes voice received from the A/D converter 22 and converts the recognized voice into text data. An internal construction of the voice recognition unit 27 is well known to those skilled in the art. Therefore, description thereof will be omitted for simplicity.

An affirmative sentence table 40 is connected to the IVR module 24 and is a memory that provides words, phrases, clauses and sentences, which are required by the IVR module 24. Words, phrases, clauses and sentences that are frequently used can be added to or updated in the table 40 by the controller 20. To this end, a representative example of the table 40 can be a flash memory.

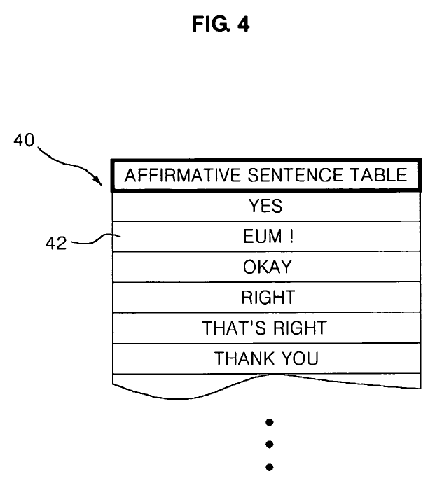

FIG. 4 shows a part of a register map of the affirmative sentence table 40 in FIG. 3. As shown in FIG. 4, a variety of affirmative sentence data for confirming a recognized floor number are recorded in respective registers 42 of the table 40. The affirmative sentences can be added, deleted or modified, if appropriate, and can also be stored in various languages (e.g., English, Chinese, Japanese, etc.). The reason why the affirmative sentence table 40 is required is that a passenger's response can be different when a recognized floor number is asked in return.

The speaker 16 receives a voice output from the controller 20 and lets a passenger hear. Furthermore, one of output terminals of the controller 20 functions to transmit a button input value that is specified by a Central Processing Unit (CPU) of the elevator 10.

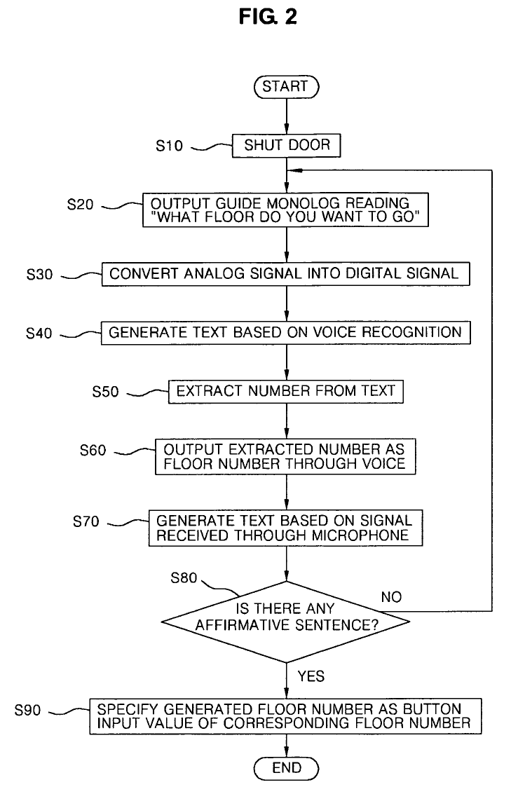

Hereinafter, an operational sequence of the elevator constructed above will be described in detail. FIG. 2 is a flowchart illustrating an operational sequence of the elevator shown in FIG. 1.

Referring to FIG. 2, if a passenger boards the elevator 10, the door 12 is shut (S10).

Thereafter, the controller 20 controls the IVR module 24 to output a guide monolog reading “What floor do you want to go” through the speaker 16 (S20).

If the passenger says, e.g., “a fifth floor”, the microphone 14 receives his or her voice . The A/D converter 22 converts the analog signal into a digital signal and transmits the converted signal to the controller 20 (S30).

Thereafter, the controller 20 transmits the received digital signal to the voice recognition unit 27 so that the voice recognition unit 27 converts the digital signal into a text (a sentence “fifth floor”) (S40).

The controller 20 then extracts the number (“5”) from the text (the sentence “fifth floor”) (S50).

Thereafter, the controller 20 sends the extracted number (“5”) to the IVR module 24 so that the IVR module 24 outputs voice corresponding to the number or voice in which the number is combined (e.g., “Is it a fifth floor?”) through to the speaker 16 (S60). This is for allowing the passenger to confirm the recognized floor number.

If the passenger gives a positive answer (e.g., “okay”), the microphone 14 receives the answer. The A/D converter 22 converts the analog signal into a digital signal and transmits the converted signal to the controller 20. Furthermore, the controller 20 transmits the received digital signal to the voice recognition unit 27 so that the voice recognition unit 27 converts it into a text (a sentence “okay”) (S70).

The controller 20 then controls the IVR module 24 to determine whether the converted text and the affirmative sentences stored in the affirmative sentence table 40 have the mutual similarity of a predetermined value (e.g., 90% or higher) (S80). If there is no answer corresponding to the affirmative sentence table 40 or the similarity is low, the process again begins from the guide monolog step (S20).

Thereafter, if there is an affirmative sentence of the text, the controller 20 specifies a corresponding floor number as a button input value (S90) and transmits the specified floor number to the CPU. Therefore, the CPU can operate the elevator in the same processing method as that in which the button of a corresponding floor number is pressed.

In the present specification, it has been described that one microphone and one speaker are used. However, in the case of a large-scale elevator, a plurality of microphones and speakers can be used. When the surrounding noise is loud, an additional filter device can be mounted in an elevator.

Furthermore, it will be evident to those skilled in the art that not only a floor number can be specified, but also a specified floor number can be canceled using the same construction. In addition, in the case where a floor number of a button that has been pressed by one person is spoken by the other person, a guide monolog reading that “The button has already been pressed” can be given. Furthermore, a guide monolog can be a woman's voice, a man's voice or the like and can be given in any language (Korean, English, Japanese, Chinese, etc.)

As described above, according to an embodiment of the present invention, a passenger who boards an elevator can specify a desired floor number using his voice. Therefore, inconvenience in which a passenger has to press buttons can be removed and convenience can be enhanced when there are lots of people in one elevator.

Furthermore, since a passenger can confirm a floor number recognized through voice, an elevator can operate without error. Therefore, there is an advantage in that reliability of an elevator can be enhanced.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An elevator in which a floor number is specified through voice recognition, comprising:
a microphone installed within an elevator;
voice recognition means for recognizing voice information received from the microphone and generating the recognized voice information as text data;
extraction means extracting an associated number based on the generated text data; and
specifying means for specifying the associated number extracted by the extraction means as a button input value of a floor number to which the elevator will move.

2. The elevator as claimed in claim 1, further comprising:
converting means for converting the associated number extracted by the extraction means into voice data; and
a speaker installed within the elevator for outputting the voice data.

3. The elevator as claimed in claim 2, further comprising determination means for determining whether affirmative sentences are included in the text data generated through the microphone and the voice recognition means after the speaker has output the voice data.

4. The elevator as claimed in claim 1, wherein the voice recognition means comprises an affirmative sentence table that includes voice data regarding an affirmative answer.

5. The elevator as claimed in claim 1, wherein the microphone is installed at a central region of the ceiling of the elevator.

6. The elevator as claimed in claim 1, further comprising an A/D converter that converts the voice information received from the microphone into a digital signal.

7. The elevator as claimed in claim 3, wherein the voice recognition means comprises an affirmative sentence table that includes voice data regarding an affirmative answer.
